(19) United States
(12) Patent Application Publication
(10) Pub. No.: US 2004/0183630 A1
(43) Pub. Date: Sep. 23, 2004

(54) Microwave resonant circuit and tunable microwave filter using same

(76) Inventors: Gerard Tanne, Ploudaniel (FR); Erwan Salahun, Brest (FR); Patrick Queffelec, Brest (FR); Olivier Acher, Monts (FR); Anne Lise Adenot, Tours (FR)

Correspondence Address: Thelen Reid & Priest, PO Box 640640, San Jose, CA, 95164-0640, US

(21) Appl. No.: 10/485,245

(22) PCT Filed: Jul. 31, 2002
(86) PCT No.: PCT/FR02/02762

(30) Foreign Application Priority Data
Aug. 2, 2001 (FR) 0110395

(51) Int. Cl. H01P 7/08

(52) U.S. Cl. 333/219.2; 333/204

(57) ABSTRACT

The invention relates to a resonant ultra-high frequency circuit and a tuneable ultra-high frequency filter using the resonant circuit. The resonant circuit comprises at least one resonant microstrip line element, the resonant microstrip line element comprising a conducting ribbon (1) and a ground plane (4). The resonant circuit comprises at least one composite element (3) composed of an alternation of ferromagnetic layers and insulating layers located between the conducting ribbon and the ground plane.

The invention is applicable to any transmission/reception device using frequency tuning in the ultra-high frequencies field, for example such as multi-band mobile telephones.

### TECHNICAL DOMAIN AND PRIOR ART

The invention relates to a resonant ultra-high frequency circuit and a frequency tuneable ultra-high frequency filter using the resonant circuit.

The invention is applicable to any transmission/reception device using frequency tuning starting from a magnetic or mechanical control in the ultra-high frequencies field, for example such as multi-band mobile telephones.

The development of ultra-high frequency applications requires the use of increasingly high performance ultra-high frequency functions (better radioelectric performances, lower consumption, large scale miniaturisation, frequency agility, low manufacturing and wiring costs).

Frequency tuneable filters form a particularly important family of ultra-high frequency functions. There are various ways of making frequency tuneable filters according to known art.

For example, the frequency can be tuned using diode type electronic components (varactor diode or PIN diode). Electronic component filters then have significant insertion losses and high noise levels due to the use of electronic components.

Frequency tuneable filters can also be made of ferroelectric materials. These filters have the advantage that their noise levels are relatively low but they require control voltages that can be high and are characterised by high insertion losses.

Tuneable filters using a magnetic material are also known.

The most widespread filters use ferrimagnetic materials like ferrites or yttrium garnets (YIG). They have the disadvantage that they require a large static control magnetic field, which requires the use of coils through which a high intensity current passes. Their operation is based on variation of the gyromagnetic permeability under the effect of an external field, such that a “demagnetising field” has to be overcome to create a given magnetic field inside the magnetic component. The control field must be equal to the internal field plus the demagnetising field. For solid materials, the demagnetising field may be calculated as a function of the shape of the sample. For example, consider a flat ferrite parallelepiped for which the height to side ratio is equal to 1/10. The demagnetising field can then reach values of the order of 7% of magnetisation at saturation. For a ferrite, this represents a control field of the order of 24 kA/m to be added to the useful field. Values of this magnitude are a problem.

Ferromagnetic materials are also used to make ultra-high frequency filters. Unlike ferrites, the conducting nature of ferromagnetic materials imposes additional constraints to prevent conductivity losses from opposing propagation of the waves. Microstrip in line filters have been made including one or several ferromagnetic layers (see “Tuneable microstrip device controlled by a weak magnetic field using ferromagnetic laminations” A. L. Adenot, O. Acher, T. Taffary, P. Quéffélec, G. Tanné, JOURNAL OF APPLIED PHYSICS, May 1, 2000).

The layer(s) of ferromagnetic material is (are) inserted between the input port and output port of a microstrip line. The filters thus made are stop-band filters, in which the bandwidth depends only on the width of the gyromagnetic absorption line of the ferromagnetic material. Filtering is then the result of selective losses in the ferromagnetic material. The width of the absorption line is of the order of a few hundred MHz and it is almost impossible to modify it.

The invention does not have the disadvantages and limitations of the various known filters mentioned above.

### PRESENTATION OF THE INVENTION

The invention relates to a resonant ultra-high frequency circuit comprising at least one resonant microstrip line element, the resonant microstrip line element comprising a conducting ribbon and a ground plane. The resonant ultra-high frequency circuit comprises at least one composite element composed of an alternation of ferromagnetic layers and insulating layers located between the conducting ribbon and the ground plane.

The invention also relates to a frequency tuneable ultra-high frequency filter comprising at least one resonant ultra-high frequency circuit. The resonant ultra-high frequency circuit is a resonant circuit according to the invention and the ultra-high frequency filter comprises means of applying a magnetic field to the composite element.

In the remainder of this description, a composite element composed of an alternation of ferromagnetic layers and insulating layers will also be referred to by the abbreviation LIFT for “Ferromagnetic Edge Insulating Lamination”. For example, this type of composite element is described in the French patent No. 2 698 479 entitled “Composite hyperfrequence anisotrope”.

For example, the resonant microstrip line element may be an open circuit with a length equal to λ_{g}/4, or a short circuit stub with a length equal to λ_{g}/2, or a line element with a length equal to approximately λ_{g}/2, where λ_{g} is the wave length being propagated in the line element. As an expert in the subject is fully aware, the term “stub” means a line element in open circuit or in short circuit placed in parallel with a main propagation line.

The ferromagnetic and insulating layers are stacked parallel to the conducting ribbon and to the ground plane. Preferably, the ferromagnetic layers are between 0.05 μm and 2 μm thick and the insulating layers are between 2 μm and 50 μm thick. Preferably, the fraction of ferromagnetic material by volume is between 0.2% and 20%. Also preferably, the product of the susceptibility of the ferromagnetic material |μ−1| and the fraction of ferromagnetic material by volume f, is between 0.5 and 300. Preferably, magnetisation of the ferromagnetic layers at saturation is more than 400 kA/m.

For example, a LIFT structure comprises a stack of ferromagnetic layers deposited on a flexible mylar or kapton substrate. The stacked layers are glued to each other, for example such that the stack thickness is between 50% and 100% of the total thickness of the substrate of the microstrip line.

The use of a LIFT composite advantageously makes it possible to control frequency tuning with relatively low magnetic fields. Preferably, the magnetic field is between 80 A/m and 25 kA/m. This also enables easier mass production at much lower cost than if a ferrimagnetic material is used.

The device for controlling the resonant frequency and the gyromagnetic permeability of LIFT composites may be composed of a static magnetic field source acting on the LIFT in a direction parallel to the ferromagnetic layers. For example, the magnetic field source may be a system of coils through which a current passes, or a permanent magnet.

The frequency control may also be made by applying a stress on the LIFT, parallel to the plane of the ferromagnetic layers. In this case, the ferromagnetic layers that make up the LIFT must have a non-negligible magnetostriction coefficient, for example with an absolute value of the order of 3 to 35×10⁻⁶. The applied stress can then be used to modify the intensity and direction of the internal field in the ferromagnetic layers. For example, the applied stress may be between 10 and 800 MPa.

### BRIEF DESCRIPTION OF THE FIGURES

Other characteristics and advantages of the invention will appear after reading a preferred embodiment of the invention with reference to the attached Figures, in which:

FIG. 1 is an example showing the measured relative permeability of a ferromagnetic film layer;

FIG. 2 shows an example of the transmission coefficient for a structure composed of a microstrip line and a LIFT composite as a function of the frequency, for different line widths;

FIGS. 3A and 3B show a first example embodiment of a resonant ultra-high frequency circuit according to the invention;

FIG. 4 shows the transmission coefficient of a frequency tuneable ultra-high frequency filter comprising a resonant circuit like that shown in FIGS. 3A and 3B;

FIG. 5 shows a resonant ultra-high frequency circuit of the frequency skip resonator type according to the invention;

FIG. 6 shows the reflection and transmission responses of a frequency tuneable ultra-high frequency filter comprising a resonant circuit like that shown in FIG. 5,

FIG. 7 shows a resonant ultra-high frequency circuit with capacitive coupling according to the invention.

The same marks denote the same elements in all FIGS.

### DETAILED DESCRIPTION OF EMBODIMENTS OF THE INVENTION

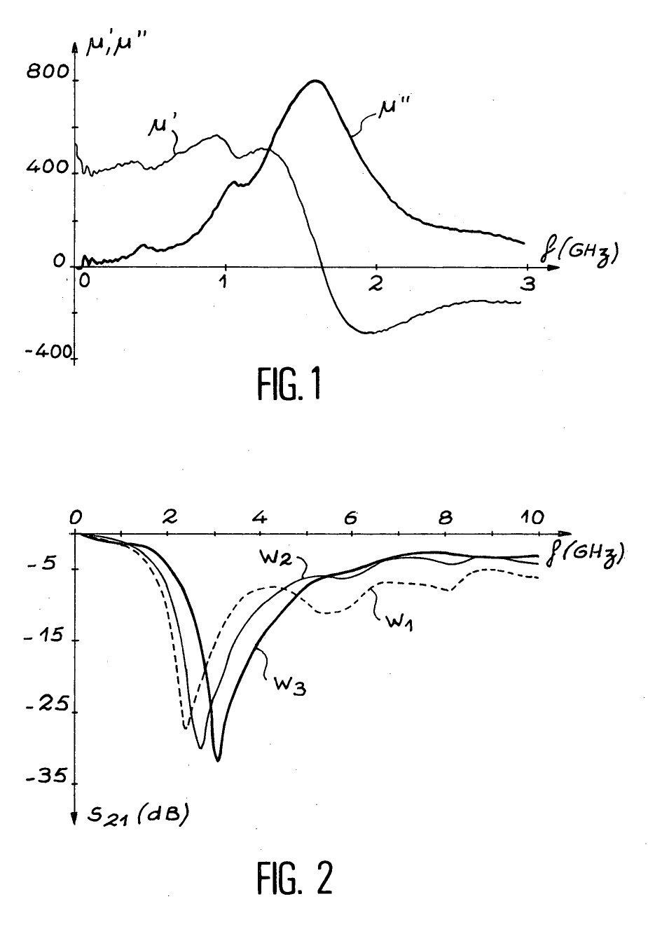

FIG. 1 shows the measured relative permeability of a ferromagnetic film layer. As a non-limitative example, the thickness of the ferromagnetic film layer is equal to 0.43 μm.

As an expert in the subject will be aware, the relative permeability, of a medium is represented by a complex number:

μ=μ′−j μ″

FIG. 1 shows the real part μ′ and the imaginary part μ″ of the relative permeability μ as a function of the frequency.

The natural resonant frequency of the ferromagnetic material is characterised by when the real part μ′ is equal to 1 and when the imaginary part μ″ is equal to a maximum value. In the example shown in FIG. 1, the resonant frequency is around 1.6 GHz. The width of the imaginary permeability peak μ″ is typically a few hundred MHz (for example 700 MHz in the case studied).

The relative permeability at a few hundred MHz below the gyromagnetic resonant frequency is essentially real. Therefore, there are few or no losses. Advantageously, the ferromagnetic material according to the invention is used in this frequency zone.

FIG. 2 shows an example of the transmission coefficient of a structure composed of a microstrip line and a LIFT composite as a function of the frequency, for different line widths. The transmission coefficient is expressed in decibels (S₂₁(dB)) for three different line widths (W₁=3.3 mm; W₂=4.2 mm; W₃=6 mm).

A microstrip line is composed of a conducting ribbon and a ground plane in a known manner, the conducting ribbon and the ground plane being separated by a dielectric medium. In the structure for which measurements are illustrated in FIG. 2, the ferromagnetic composite is placed between the conducting ribbon and the ground plane of the microstrip line. The ribbon in the example chosen is 4.2 mm wide.

The use of lamination ferromagnetic composites in ultra-high frequency introduces losses due to the appearance of currents induced in the ferromagnetic layers. These induced currents result from the presence of ultra-high frequency electric field components in the ferromagnetic layers plane. FIG. 2 clearly shows that the ribbon width must be greater than or equal to the width of the LIFT ferromagnetic composite, to limit these losses. The measured response of the device actually shows that for a ribbon width less than the width of the LIFT composite (W₁=3.3 mm), the level of insertion losses is much greater at high frequency (in other words above the absorption peak) than for a ribbon width equal to or greater than the width of the ferromagnetic composite (W₂=4.2 mm; W₃=6 mm).

Furthermore, the resonant frequency is sensitive to the effect of dynamic demagnetising fields. The effect of these fields is to offset the magnetic absorption frequency towards high frequencies. This offset of the resonant frequency is due to the creation of magnetic poles on the surface of the ferromagnetic composite when the ultra-high frequency magnetic field penetrates into and leaves the magnetic substrate. The numeric study of the geometric characteristics of the line confirms this resonant frequency.

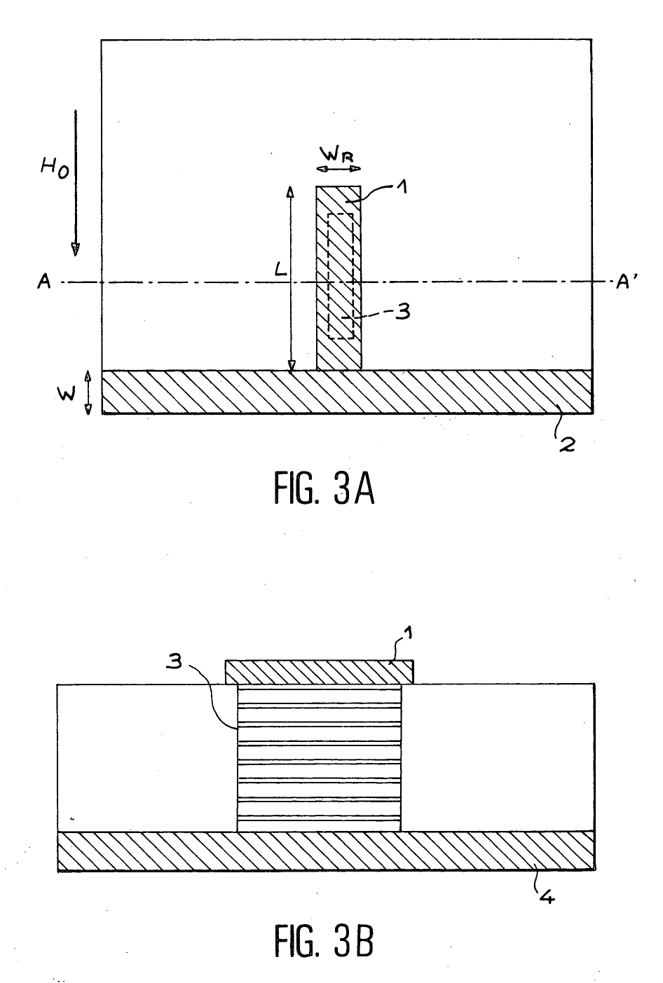

FIGS. 3A and 3B show a first example embodiment of a resonant ultra-high frequency circuit according to the invention. FIG. 3A is a top view of the resonant circuit, and FIG. 3B is a view along section AA′ in FIG. 3A.

This first example of a resonant circuit shows the feasibility of a variable frequency first order type band-stop filter according to the invention. The frequency agility is then achieved by varying the magnetic properties of the LIFT composite under the action of an external static field Ho or an external stress.

A ribbon 1 with width W_{R} is installed in parallel with a ribbon 2 with width W typically corresponding to the input and output impedances of the device. A LIFT composite 3 is placed between the ribbon 1 and the ground plane 4. The ribbon 1 with width W_{R} installed in parallel with the ribbon 2 forms a resonant line element.

The resonant frequency of the band-stop function is controlled by the length L and the width W_{R} of the ribbon 1 and by the intrinsic parameters (permittivity and permeability) of the medium that separates the ribbon 1 from the ground plane 4.

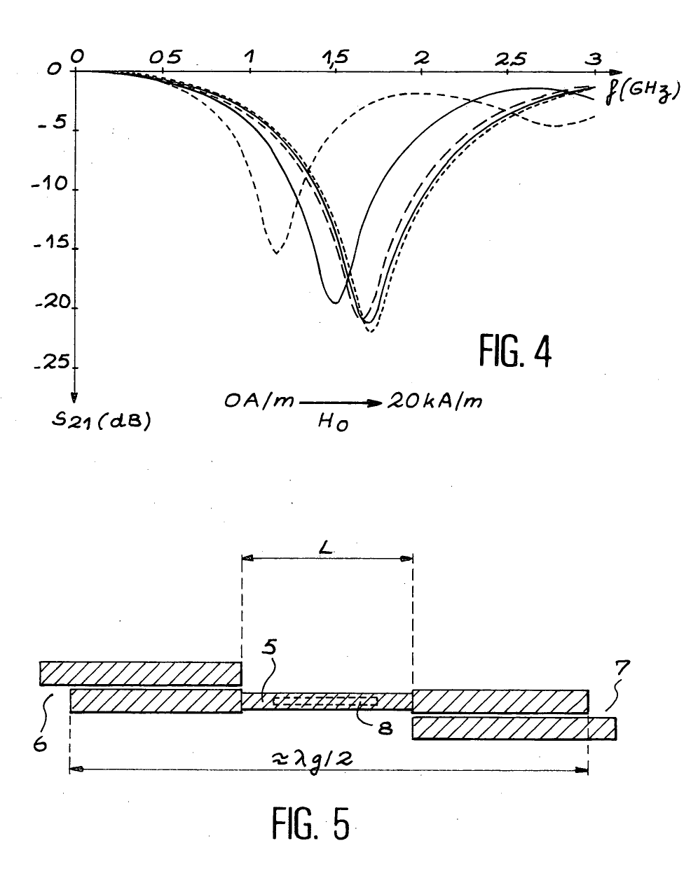

When one of these parameters is modified by applying an external disturbance, the corresponding impedance in the bypass plane is different and the resonant frequency is then modified. In the demagnetised state, the impedance of the material is high due to the high value of the permeability. When the material is saturated, the relative permeability tends to 1 and the resonant frequency tends to be the frequency calculated for a dielectric substrate. Thus, a frequency agile band-stop function with magnetic control can be made. FIG. 4 thus illustrates the transmission coefficient in decibels (S₂₁ dB) of an ultra-high frequency filter using a resonant circuit like that shown in FIGS. 3A and 3B for different values of the applied magnetic field Ho (where Ho varies from 0 A/m to 20 kA/m).

The advantage of the filter device according to the invention is that the bandwidth of the filter can be controlled to a certain extent. The bandwidth of the filter advantageously depends on the electric characteristics of the “stub”, for example its length and its width. These filter devices according to known art that use a ferromagnetic material do not have this advantage since they only use gyromagnetic losses to fix the bandwidth. Thus according to the invention, it is possible for example to reduce the bandwidth by doubling the stub length and replacing the open circuit by a short circuit (the bandwidth at −3 dB is then divided by a factor of at least 2).

The LIFT composite 3 is composed of a set of layers that, for example, forms a rectangular parallelepiped. For example, each layer may be composed of a 0.43 μm thick amorphous ferromagnetic deposit of Co₈₇Nb_{11.5}Zr_{l.5} and with magnetisation at saturation equal to 875 kA/m on a kapton substrate with thickness e=12μm. For example, the deposit may be made by magnetron cathodic sputtering under a vacuum, of a ferromagnetic material onto a kapton film continuously unwound in front of the magnetron. The residual magnetic field of the magnetron at the substrate orients magnetisation of the material in a preferred direction in its plane. This direction is called the “easy magnetisation axis”. At frequencies of the order of 100 MHz and higher, the relative permeability to an ultra-high frequency field applied along the easy magnetisation direction is close to one, while the relative permeability is high in the direction of the plane of the curve orthogonal to the easy magnetisation direction.

The control magnetic field Ho may be applied using conventional field application means such as one or several coils, with or without magnetic poles or a permanent magnet. The field Ho is applied to a small volume (of the order of magnitude of the volume of the LIFT), which advantageously results in low consumption of the control circuit. The intensity of the static magnetic field may then be less than or equal to 20 kA/m, for example.

A variant of the filter according to the invention consists of tuning the filter using a mechanical stress rather than a magnetic control.

In this case, instead of being made from a layer of CoNbZr for which the magnetostriction coefficient is low, the LIFT component is made using a more strongly magnetostrictive material such as an FeCoSiB alloy, but not using compositions for which the ratio between the iron content and the cobalt content is between 2 and 10% for which it is known that the magnetostriction coefficient is fairly low. For example, an alloy such as Fe₆₆Co₁₈Si₁B₁₄ has a magnetostriction coefficient of the order of 30×10⁻⁶, while the CoNbZr in the previous example has a magnetostriction coefficient of the order of 10⁻⁶. This material also has the advantage of having a high magnetisation at saturation equal to 1430 kA/m. It is known that a mechanical stress is equivalent to an external magnetic field that is added to or subtracted from the anisotropy field of the layer (depending on the sign and the direction of application of the stress). In the previous example, a compression stress of 1 MPa in the plane of the layer is equivalent to an external field of the order of 56 A/m applied in the plane of the layer, perpendicular to the stress. The equivalent external field is proportional to the stress. Therefore, the equivalent of an external control magnetic field equal to 8 kA/m is obtained by applying a stress of the order of 140 MPa in the ferromagnetic. Since the modulus of the flexible substrate is much lower than the modulus of the ferromagnetic, the average stress to be applied to the LIFT is lower than these values, of the order of 8 MPa for a LIFT composed of a 0.4 μm thick ferromagnetic layer on a 12 μm mylar substrate. Therefore, taking account of the small size of the LIFTs, the forces involved are advantageously very low so that piezo-electric control is efficient.

The stress can be applied using an electrically controlled piezo-electric device that will constrain the LIFT composite and thus change the tuning characteristics.

A ferromagnetic thickness equal to 0.43 μm was chosen in preference because, for the material considered, significantly increasing the thickness would introduce additional losses below the resonant frequency (losses related to the skin effect), and significantly reducing this thickness would significantly reduce the ferromagnetic content in the LIFT and therefore the permeability degrees. However, note that the degree of permeability of the LIFT can be kept constant or increased even with a thinner ferromagnetic, provided that the thickness of the LIFT insulation is reduced (the insulation thickness is equal to the sum of the thickness of the glue and the thickness of the dielectric substrate on which the ferromagnetic layer is deposited). It is thus possible to use 3.5 μm, or even 1.6 μm, thick mylar dielectric layers to deposit the ferromagnetic material.

The ferromagnetic deposit on the flexible film is structured in the form of a stack using an epoxy glue, the glue thickness not exceeding 5 μm. The multi-layer composite thickness is chosen to be slightly less thick than the substrate of the micro-ribbon line, namely 0.625 mm in the example presented. The parallelepiped parts of LIFT materials are then machined to the required dimensions, so as to place ferromagnetic laminations parallel to the ground plane of the micro-ribbon line.

FIG. 5 shows a stepped impedance resonator circuit according to the invention. An ultra-high frequency filter that uses a stepped impedance resonator will also be called a SIR filter (SIR stands for “Stepped Impedance Resonator”) in the remainder of this description.

The main advantage of SIR filters is their flexibility of use, and particularly the possibility of overcoming some technological constraints by determining a characteristic impedance ratio between easily synthesisable adjacent sections. SIR filters have the disadvantage that they enable parasite feedback at harmonic frequencies. It has been shown (see “Improvement of global performances of band-pass filters using non-conventional stepped impedance resonators”, S. Denis; C. Person; S. Toutain; S. Vigneron; R. Théron; EUMC, Oct. 5-7 1998, Amsterdam, p. 323, vol. 2), that the use of non-conventional stepped impedance resonators, in other words with a random breakdown of resonators, offers new prospects for the control of parasite feedback and for the control of losses and parasite effects.

SIR filters according to the invention are advantageously capable of eliminating the existence of some parasite feedback. Parasite feedback is then eliminated by making the parasite feedback coincide with the gyromagnetic resonance of the LIFT material. A variable frequency filter can then be made while controlling the first parasite feedback.

The topology of a SIR filter according to the invention is shown in FIG. 5. A ribbon 5 with length L is included between a first set of coupled lines 6 and a second set of coupled lines 7. The LIFT element 8 is placed under the ribbon 5. The assembly formed by the coupled lines 6 and 7 and the ribbon 5 forms the resonator with a total length approximately equal to λ_{g}/2. In practice, the resonator length will be slightly more than or less than λ_{g}/2 depending on the impedance ratio.

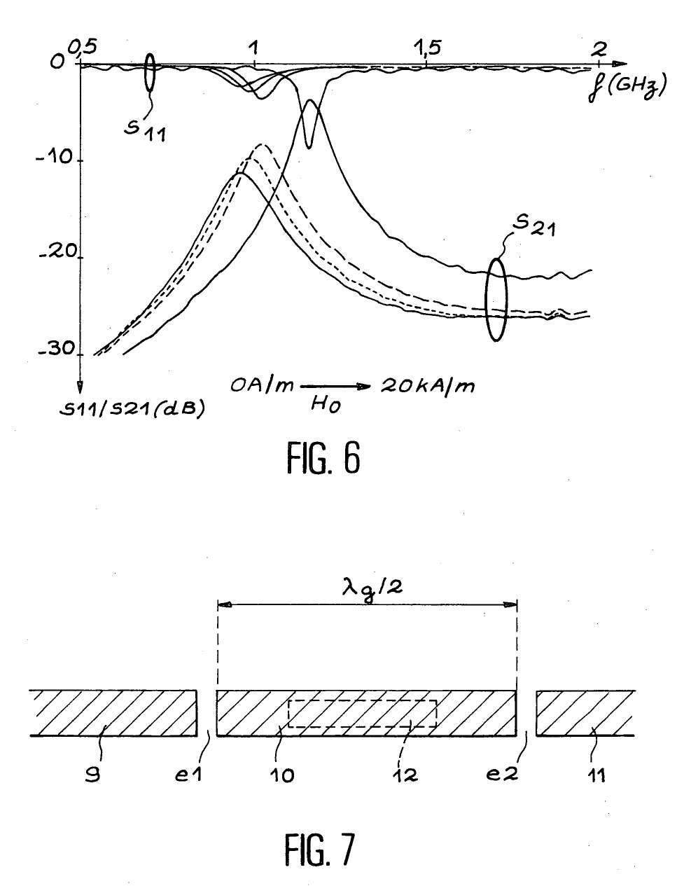

Preferably, the LIFT element is centred between the two sets of coupled lines so as not to modify the bandwidth of the filter that is fixed essentially by the coupling level of the coupled lines. Thus, by application of a static magnetic field, all that is modified is the central frequency of the filter by varying the electric length of the λ_{g}/2 line. The input and output couplings are not disturbed by the magnetic field and the bandwidth of the filter remains practically insensitive to the applied static field. The filter may for example be made on an Arlon substrate (εᵣ=3.5) so that the permittivity of the substrate is similar to the permittivity of the LIFT composite, thus reducing electromagnetic discontinuities. Measured responses for different values of the static magnetic field are shown in FIG. 6.

FIG. 6 shows values of the reflection coefficient S₁₁(dB) and the transmission coefficient S₂₁(dB) as a function of the frequency, in decibels, for an ultra-high frequency filter that uses a resonant circuit like that shown in FIG. 5 for different values of the applied magnetic field Ho (where Ho varies from 0 A/m to 20 kA/m).

A variation equal to ±24% is obtained around the value fo=1.08 GHz. FIG. 6 clearly shows that the filtered bandwidth is significantly less than the width of the gyromagnetic losses peak, which clearly illustrates the advantage and versatility of filters according to the invention compared with existing tuneable magnetic filters.

The geometric characteristics of the micro-ribbon line and the material are taken into account as described above, to improve the filter response in terms of the level of insertion losses.

FIG. 7 shows a third example of a resonant circuit according to the invention. The circuit shown in FIG. 7 is a circuit with capacitive coupling and with a λ_{g}/2 resonator. There is a line element 10 with length λ_{g}/2 between two lines 9 and 11. Capacitive coupling is made by a first space e1 separating line 9 and line element 10 and a second space e2 that separates the line 9 and line element 11. A LIFT composite 12 is placed centrally under the line element 10.

1. Resonant ultra-high frequency circuit comprising at least one resonant microstrip line element, the resonant microstrip line element comprising a conducting ribbon and a ground plane, characterised in that it comprises at least one composite element composed of an alternation of ferromagnetic layers and insulating layers located between the conducting ribbon and the ground plane.

2. Resonant circuit according to claim 1, characterised in that the resonant microstrip line element is an open circuit or a short circuit stub placed in parallel with a main line.

3. Resonant circuit according to claim 1, characterised in that the resonant microstrip line element is a line element with a length equal to approximately λ_{g}/2, where λ_{g} , is the wave length being propagated in the line element, coupled to a main line by capacitive coupling.

4. Resonant circuit according to claim 1, characterised in that the resonant microstrip line element is composed of a line element with length L, placed between a first set of coupled lines and a second set of coupled lines, the assembly formed by the microstrip line element and the first and second sets of coupled lines having a total length approximately equal to λ_{g}/2, where λ_{g} is the wave length being propagated in the line element.

5. Resonant circuit according to any one of the previous claims, characterised in that the composite element is in the form of a rectangular parallelepiped the width of which is slightly less than the width of the ribbon, the rectangular parallelepiped being centred under the ribbon.

6. Resonant circuit according to claim 5, characterised in that the thickness of the composite element is between 50% and 100% from the distance separating the ribbon and the ground plane.

7. Resonant circuit according to claim 1, characterised in that the insulating layers of the composite element are made of kapton or mylar.

8 Frequency tuneable ultra-high frequency filter comprising at least one resonant circuit characterised in that the resonant circuit is a circuit according to any one of claims 1 to 7 and in that it comprises means of applying a magnetic field to the composite element.

9. Ultra-high frequency filter according to claim 8, characterised in that the means of applying a magnetic field comprise at least one coil through which a current passes and/or a permanent magnet.

10. Ultra-high frequency filter according to either of claims 8 or 9, characterised in that the ferromagnetic material is Co₈₇Nb_{11.5}Zr_{1.5}.

11. Ultra-high frequency filter according to claim 8, characterised in that the means of applying a magnetic field are means of applying a mechanical stress on the composite element and in that the ferromagnetic layers are made of a magnetostrictive material.

12. Ultra-high frequency filter according to claim 11, characterised in that the magnetostrictive material is an FeCoSiB alloy, but not using compositions for which the ratio between the cobalt content (Co) and the iron content (Fe) is between 2 and 10%.
